(19) United States
(12) Patent Application Publication
(10) Pub. No.: US 2013/0063945 A1
(43) Pub. Date: Mar. 14, 2013

(54) BULB-TYPE LED LAMP HAVING REPLACEABLE LIGHT SOURCE MODULE

(71) Applicants: Huei-Jan WU, New Taipei City (TW); Zu-Chao Hsu, New Taipei City (TW)

(72) Inventors: Huei-Jan WU, New Taipei City (TW); Zu-Chao Hsu, New Taipei City (TW)

(73) Assignee: CHAUN-CHOUNG TECHNOLOGY CORP.

(21) Appl. No.: 13/230,780

(22) Filed: Sep. 12, 2011

(51) Int. Cl. F21S 4/00

(52) U.S. Cl. 362/249.02

(57) ABSTRACT

A bulb-type LED lamp having a replaceable light source module includes a lamp head module, a lamp casing module and a light source module. The lamp head module has an electrical-conductive connection portion. One end of the lamp casing module is connected to the lamp head module. The light source module comprises a substrate, a plurality of LEDs electrically connected to the substrate, and a sleeve disposed in the lamp casing module to be electrically connected to the substrate. The sleeve has an electrical-conductive insertion portion assembled with the electrical-conductive connection portion. By this structure, a damaged light source module can be replaced rapidly. A user needs not to by a new whole set lamp so as to save the cost maintenance. Further, a surface thermal contact is generated between the metallic pressing plate and the heat-conducting plate to increase the heat-conducting area and efficiency.

### BACKGROUND OF THE INVENTION

1. Field of the Invention

The present invention relates to a lamp, and in particular to a bulb-type LED lamp having a replaceable light source module.

2. Description of Prior Art

With the rapid advance of science and technology, light-emitting diodes (LEDs) are widely used in lighting apparatuses to replace traditional incandescent bulb because the LEDs are low in electricity consumption, high in brightness, long in lifetime and etc. A conventional bulb-type lamp includes a lamp head, a heat-dissipating casing, a circuit board, a plurality of LED arranged on the circuit board, and a lamp cover. Generally speaking, the heat-dissipating casing is made of metals having high thermal conductivity, which is long in lifetime and hard to damage. In comparison with the heat-dissipating casing, the LED or the circuit board of the light source module is prone to burn down or break down. Hence, when the light source module breaks down, the user has to discard the damaged light source module together with the heat-dissipating casing, the lamp head and the lamp cover, which wastes a lot of usable components for the user and thus does not conform to the requirement for environmental protection. If the LED or the light source module could be replaced by a new one, the money for maintenance can be saved and the waste of usable components is reduced, which conforms to the requirements for environmental protection.

Another problem of the conventional bulb-type LED lamp lies in that: the heat generated by the LED cannot be effectively conducted to the heat-dissipating casing because the LEDs are arranged on the circuit board and the thermal contact area between the circuit board and the heat-dissipating casing is insufficient. As a result, the whole heat-dissipating effect is insufficient, so that the circuit board and the LED of the light source module may be burn down easily.

Therefore, it is an important issue for the present Inventor to solve the above problem.

### SUMMARY OF THE INVENTION

The present invention is to provide a bulb-type LED lamp having a replaceable light source module, whereby the light source module can be replaced by a new one rapidly and the maintenance cost is reduced to conform to the requirements for environmental protection.

The present invention provides a bulb-type LED lamp having a replaceable light source module, including:

a lamp head module having an electrical-conductive connection portion;

a lamp casing module with its one end connected to the lamp head module; and

a light source module comprising a substrate, a plurality of LEDs electrically connected to the substrate, and a sleeve disposed in the lamp casing module to be electrically connected to the substrate, the sleeve having an electrical-conductive insertion portion, the electrical-conductive insertion portion being assembled with the electrical-conductive connection portion.

The present invention provides a bulb-type LED lamp having a replaceable light source module, including:

a lamp head module having an electrical-conductive connection portion; and

a light source module comprising a substrate, a plurality of LEDs electrically connected to the substrate, and a sleeve electrically connected to the substrate, the sleeve having an electrical-conductive insertion portion, the electrical-conductive insertion portion being assembled with the electrical-conductive connection portion.

In comparison with prior art, the present invention has advantageous features as follows:

According to the present invention, since the light source module is detachably and electrically connected to the lamp head module in such a manner that the sleeve is disposed into the lamp casing module, when the LED or the circuit board of the light source module burns down, the sleeve can be detached from the lamp casing module to replace the damaged light source module with a new one. The original lamp head module and the lamp casing module of the lamp can be reused, so that the user needs not to buy another whole set of the bulb-type lamp. Therefore, the maintenance cost is saved greatly and the waste of usable components is reduced to conform to the requirements for environmental protection.

Since the light source module of the present invention can be replaced rapidly, the LEDs of different colors can be selectively used to change the color of light of the lamp, which increases the practicability and convenience of the lamp.

According to another feature of the present invention, the light source module comprises a metallic pressing plate. The upper surface of the metallic pressing plate is brought into thermal contact with the substrate arranged with the LEDs thereon. The lower surface of the metallic pressing plate tightly abuts a heat-conducting plate of the lamp casing module to form thermal contact. Further, the heat-conducting plate is brought into thermal contact with a heat-dissipating body of the lamp casing module. Thus, the heat generated by the LEDs is conducted from the substrate to the metallic pressing plate, the heat-conducting plate and the heat-dissipating body, and is finally dissipated to the outside via the heat-dissipating body. Since the thermal contact among the substrate, the metallic pressing plate and the heat-conducting plate is generated by a planar surface, the thermal contact area is sufficient, whereby the heat-conducting effect and the heat-dissipating effect are improved greatly.

### BRIEF DESCRIPTION OF DRAWING

FIG. 1 is an exploded perspective view showing a first embodiment of the present invention;

FIG. 2 is an exploded perspective view showing the first embodiment of the present invention;

FIG. 3 is an assembled perspective view showing the first embodiment of the present invention;

FIG. 4 is an assembled cross-sectional view showing the first embodiment of the present invention;

FIG. 5 is an assembled cross-sectional view showing a second embodiment of the present invention; and

FIG. 6 is an assembled cross-sectional view showing a third embodiment of the present invention.

### DETAILED DESCRIPTION OF THE INVENTION

The detailed description and technical contents of the present invention will become apparent with the following detailed description accompanied with related drawings. It is noteworthy to point out that the drawings is provided for the illustration purpose only, but not intended for limiting the scope of the present invention.

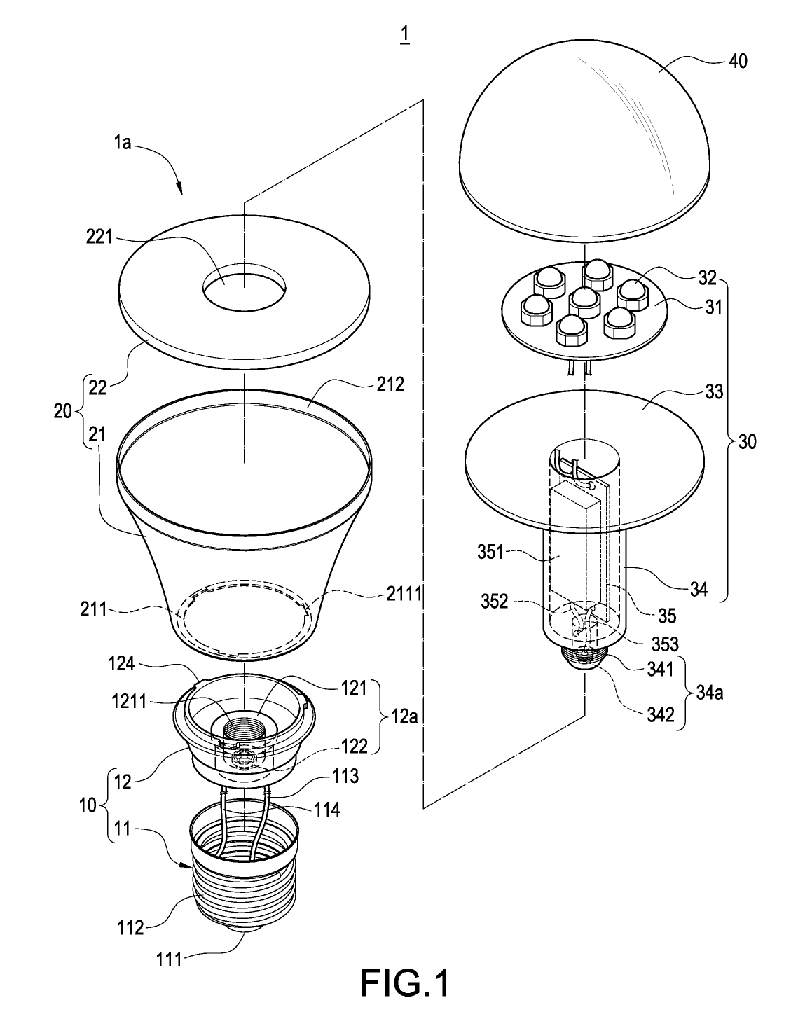

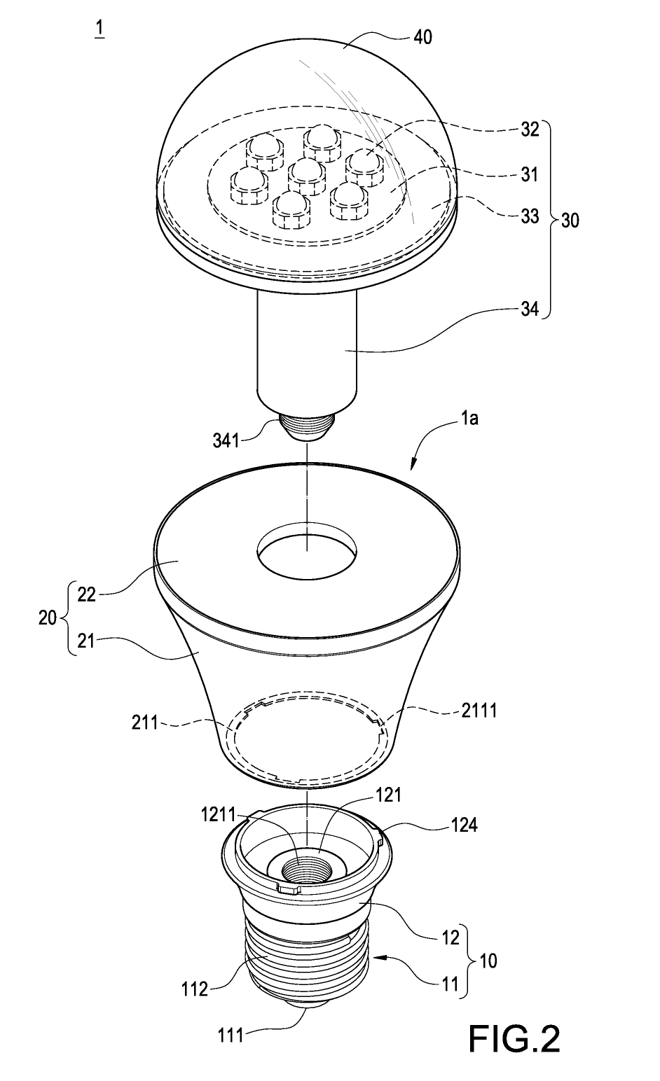

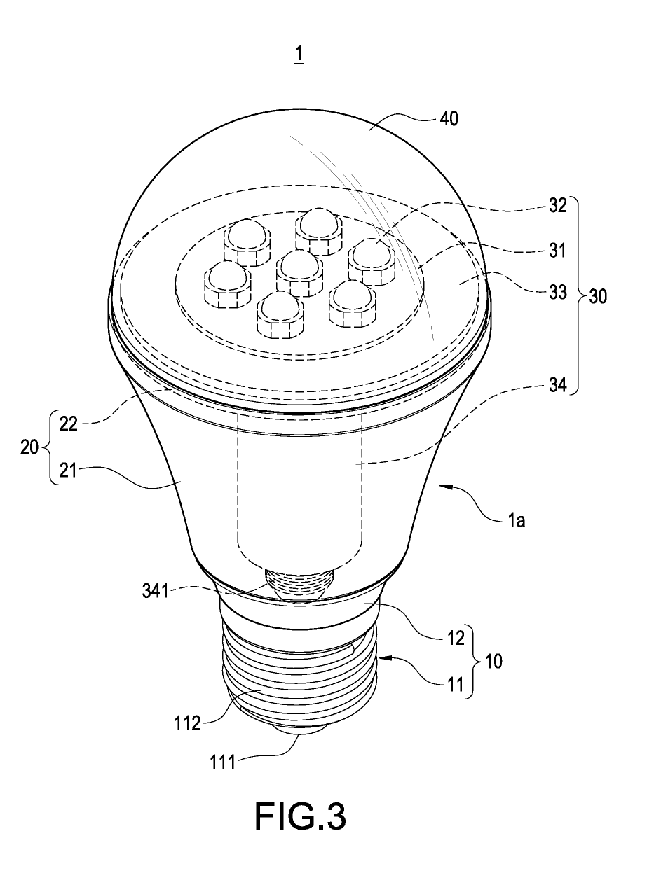

Please refer to FIGS. 1 to 4, which show the first embodiment of the present invention. The present invention provides a bulb-type lamp 1 having a replaceable light source module, which includes a lamp head module 10, a lamp casing module 20, and a light source module 30. It can be clearly seen from FIGS. 2 and 3 that, the lamp head module 10 is combined with the lamp casing module 20 to form a lamp body 1a. Then, the light source module 30 is inserted into the lamp body 1a in such a manner that the light source module 30 is disposed into the lamp casing module 20 to be assembled with the lamp head module 10. By this structure, the light source module 30 can be replaced rapidly.

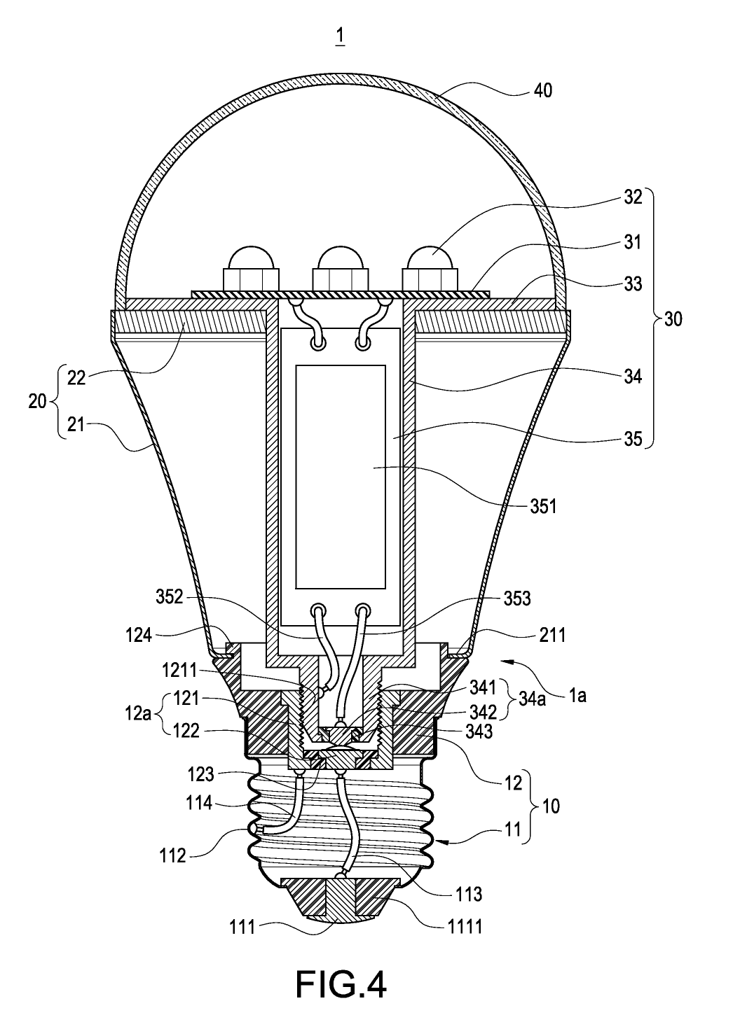

As shown in FIG. 1, the lamp head module 10 comprises a threaded head 11 and a connecting piece 12 connected to the threaded head 11. The threaded head 11 is a common so-called “Edison connector”, which is made of metallic material and has a first contact 111 and a second contact 112. As shown in FIG. 4, an insulation portion 1111 is provided between the first contact 111 and the second contact 112 to protect the electrical short circuit between the first contact 111 and the second contact 112. The first contact 111 and the second contact 112 are electrically connected to two leads 113, 114. The other ends of these two leads 113, 114 are electrically connected to the interior of the connecting piece 12. More specifically, the connecting piece 12 is assembled with the threaded head 11 by means of soldering or binding in an electrical-insulated manner, thereby forming the lamp head module 10. The interior of the connecting piece 12 has an electrical-conductive connection portion 12a. The electrical-conductive connection portion 12a comprises an electrical-conductive ring 121 and an electrical-conductive post 122 located in the center of the electrical-conductive ring 121. An insulation gasket 123 is provided between the electrical-conductive ring 121 and the electrical-conductive post 122, whereby the electrical-conductive ring 121 can be electrically insulated from the electrical-conductive post 122.

Both ends of the lead 113 are electrically connected to the first contact 111 and the electrical-conductive post 122. Both ends of the lead 114 are electrically connected to the second contact 112 and the electrical-conductive ring 121. In this way, the threaded head 11 can be electrically connected to the connecting piece 12. When a user screws the threaded head 11 into a socket (not shown) provided on a ceiling or wall, electricity from an external power source can be delivery into the connecting piece 12 via the threaded head 11 and then to the light source module 30, so that the lamp 1 can get the necessary electricity.

The inner wall of the electrical-conductive ring 121 is provided with an inner threaded hole 1211 for allowing the light source module 30 to be threadedly connected therein. The upper edge of the connecting piece 12 is formed with three protrusions 124 for allowing the lamp casing module 20 to be assembled therewith.

The lamp casing module 20 comprises a heat-dissipating body 21 and a heat-conducting plate 22 brought into thermal contact with the heat-dissipating body 21. The heat-dissipating body 21 is made of metallic materials and formed into a truncated cone. The lower edge of the heat-dissipating body 21 is formed with a lower folded flange 211 having three notches 2111. After the three protrusions 124 of the connecting piece 12 pass through the three notches 2111 of the lower folded flange 211 respectively, the connecting piece 12 is rotated a certain angle with the three protrusions 124 resting on the lower folded flange 211, whereby the connecting piece 12 is assembled with the heat-dissipating body 21. The upper edge of the heat-dissipating body 21 is formed with an upper folded flange 212 for allowing the heat-conducting plate 22 to be disposed thereon. The heat-conducting plate 22 is made of metallic materials and provided at its center with a through-hole 221 for allowing the light source module 30 to be disposed through.

The light source module 30 is disposed through the lamp casing module 20 and assembled with the lamp head module 10. The light source module 30 comprises a substrate 31, a plurality of LEDs 32 electrically arranged on the substrate 31, a metallic pressing plate 33 brought into thermal contact with the substrate 31 and the heat-conducting plate 22, a sleeve 34 extending from the metallic pressing plate 33 and detachably connected to the inner threaded hole 1211, and an electrical unit 30 disposed in the sleeve 34 to be electrically connected to the respective LEDs 32 and the lamp head module 10. The electrical unit 35 is provided with a transformer 351 for converting the voltage of an external power source into a suitable operating voltage necessary for the LEDs 32.

The metallic pressing plate 33 and the sleeve 34 are made of metallic materials having high heat conductivity, both of which form a T-shaped structure. The sleeve 34 has an electrical-conductive insertion portion 34a comprising a threaded post 341 and a connecting post 342. The threaded post 341 is configured to screw into the inner threaded screw 1211 of the electrical-conductive ring 121. The interior of the threaded post 341 has the connecting post 342 and an insulation gasket 343 located around the connecting post 342.

The electrical unit 35 is disposed in the sleeve 34. The electrical unit 35 has a circuit board and two leads 352, 353 connected to both ends of the circuit board. One ends of the leads 352, 353 are electrically connected to the threaded post 341 and the connecting post 342 from the lower edge of the circuit board. The other ends of the leads 352, 353 are electrically connected to the substrate 31 from the upper edge of the circuit board, thereby electrically connecting all the LEDs 32. In this way, the electrical-conductive ring 121 of the connecting piece 12 is brought into electrical contact with the threaded post 341 of the sleeve 34, while the electrical-conductive post 122 of the connecting piece 12 is brought into electrical contact with the electrical-conductive post 342 of the sleeve 34, thereby delivering the electricity from the connecting piece 12 to the electrical unit 35 and the respective LEDs 32.

The lamp 1 of the present invention further includes a lamp cover 40 covering above the light source module 30 and fixedly connected to the lamp casing module 20. It can be seen from FIG. 3 that, the lamp cover 40 is fixed to the heat-conducting plate 22.

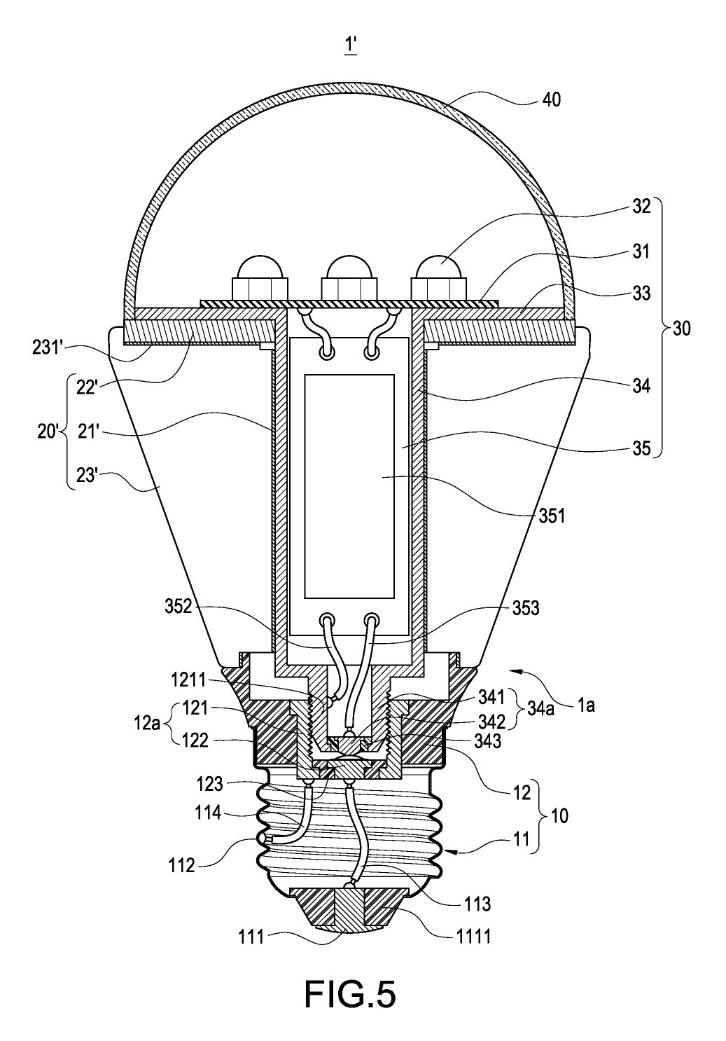

Please refer to FIG. 5, which shows the second embodiment of the present invention. The difference between the second embodiment and the first embodiment lies in that: the heat-dissipating body 21 of the first embodiment is formed into a hollow truncated cone, whereas the heat-dissipating body 21′ in the second embodiment is formed into a cylindrical shape. The outer surface of the heat-dissipating body 21′ is assembled with a plurality of heat-dissipating fins 23′. The upper edge of each heat-dissipating fin 23′ is bent to form a folded flange 231′ on which the heat-conducting plate 22′ is disposed thereon.

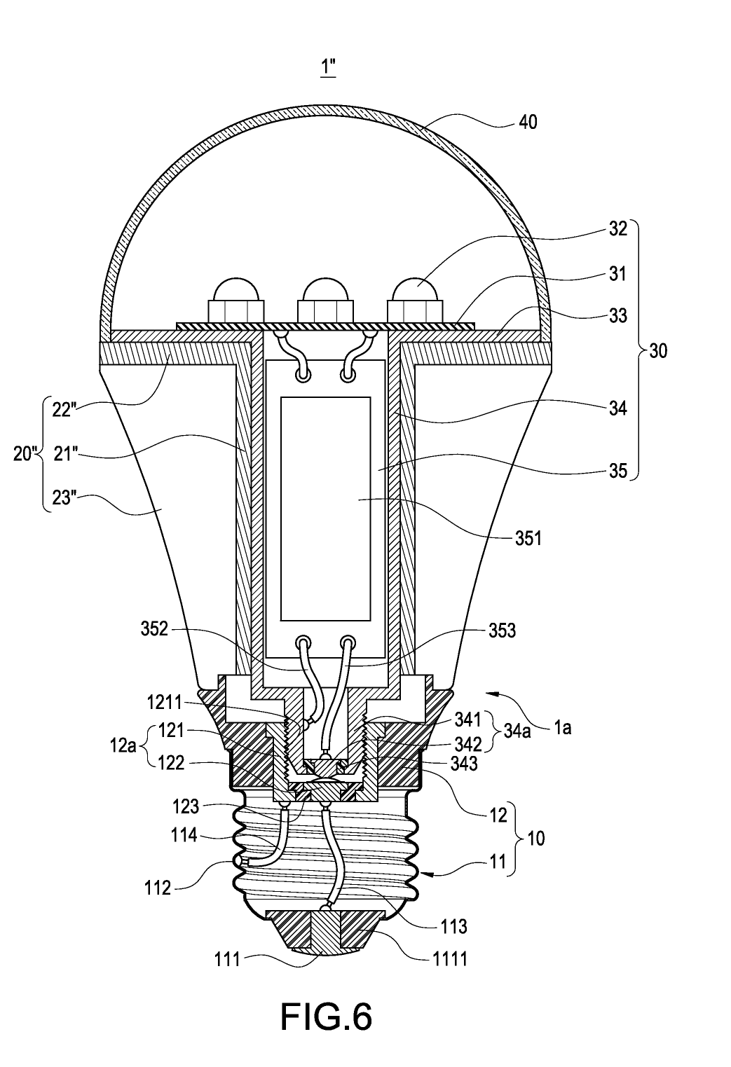

Please refer to FIG. 6, which shows the third embodiment of the present invention. The difference between the third embodiment and the second embodiment lies as follows. The heat-dissipating body 21′ of the second embodiment is formed into a cylindrical shape, and the outer surface thereof is assembled with a plurality of heat-dissipating fins 23′. The upper edge of each heat-dissipating fin 23′ is bent to form a folded flange 231′ on which the heat-conducting plate 22′ is disposed thereon. In the third embodiment, the heat-conducting plate 22″ and the heat-dissipating body 21″ are made by aluminum extrusion to form one body. The outer surface of the heat-dissipating body 21″ is formed with a plurality of heat-dissipating fins 23″. Since the heat-conducting plate 22″ and the heat-dissipating fins 23″ are formed into one body, it is unnecessary to form a folded flange on the upper edge of each heat-dissipating fin 23″.

In comparison with prior art, the present invention has advantageous features as follows:

According to the present invention, the light source module 30 is detachably and electrically connected to the lamp head module 10 in such a manner that the sleeve 34 is disposed into the lamp casing module 20. When the LED 32 or the electrical unit 35 burns down, the sleeve 34 can be detached from the lamp casing module 20 to replace the damaged light source module 30 with a new one. The original lamp head module 10 and the lamp casing module 20 of the lamp 1 can be reused, so that the user needs not to buy another whole set of the bulb-type lamp 1. Therefore, the maintenance cost is saved greatly and the waste of usable components is reduced to conform to the requirements for environmental protection.

Since the light source module 30 of the present invention can be replaced rapidly, the LEDs 32 of different colors can be selectively used to change the color of light of the lamp 1, which increases the practicability and convenience of the lamp 1.

According to the present invention, the light source module 30 comprises a metallic pressing plate 33. The upper surface of the metallic pressing plate 33 is brought into thermal contact with the substrate 31 arranged with the LEDs 32 thereon. The lower surface of the metallic pressing plate 33 tightly abuts a heat-conducting plate 22 of the lamp casing module 20 to form thermal contact. Further, the heat-conducting plate 22 is brought into thermal contact with the heat-dissipating body 21 of the lamp casing module 20. Thus, the heat generated by the LEDs 32 is conducted from the substrate 31 to the metallic pressing plate 33, the heat-conducting plate 22 and the heat-dissipating body 21, and is finally dissipated to the outside via the heat-dissipating body 21. Since the thermal contact among the substrate 31, the metallic pressing plate 33 and the heat-conducting plate 22 is generated by a planar surface, the thermal contact area is sufficient, whereby the heat-conducting effect and the heat-dissipating effect are improved greatly.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A bulb-type LED lamp having a replaceable light source module, including:
a lamp head module having an electrical-conductive connection portion;
a lamp casing module with its one end connected to the lamp head module; and
a light source module comprising a substrate, a plurality of LEDs electrically connected to the substrate, and a sleeve disposed in the lamp casing module to be electrically connected to the substrate, the sleeve having an electrical-conductive insertion portion, the electrical-conductive insertion portion being assembled with the electrical-conductive connection portion.

2. The bulb-type LED lamp having a replaceable light source module according to claim 1, wherein the lamp head module comprises a threaded head and a connecting piece connected to the threaded head, the threaded head has a first contact and a second contact, the electrical-conductive connection portion is formed on the connecting piece and comprises an electrical-conductive ring and an electrical-conductive post electrically insulated from the electrical-conductive ring, the electrical-conductive post is electrically connected to the first contact, and the electrical-conductive ring is electrically connected to the second contact.

3. The bulb-type LED lamp having a replaceable light source module according to claim 2, wherein the electrical-conductive insertion portion comprises a threaded post and a connecting post electrically insulated from the threaded post, the electrical-conductive ring is provided with an inner thread, the threaded post and the inner thread are threadedly connected with each other to from electrical connection, and the connecting post abuts against the electrical-conductive post to form electrical connection.

4. The bulb-type LED lamp having a replaceable light source module according to claim 3, wherein the lamp casing module comprises a heat-dissipating body and a heat-conducting plate brought into thermal contact with the heat-dissipating body, the light source module further comprises a metallic pressing plate extending from an end of the sleeve, and the metallic pressing plate supports the substrate and is brought into thermal contact with the heat-conducting plate.

5. The bulb-type LED lamp having a replaceable light source module according to claim 4, wherein the upper edge of the connecting piece is formed with a plurality of protrusions, the lower edge of the heat-dissipating body is formed with a lower folded flange, the lower folded flange is formed with a plurality of notches, the protrusions pass through the notches to be assembled with the heat-dissipating body, the upper edge of the heat-dissipating body is formed with an upper folded flange for allowing the heat-conducting plate to be disposed thereon, and the heat-conducting plate is provided with a through-hole for allowing the sleeve to be disposed through.

6. The bulb-type LED lamp having a replaceable light source module according to claim 4, wherein the heat-dissipating body is formed into a cylindrical shape, an outer surface of the heat-dissipating body is assembled with a plurality of heat-dissipating fins, an end of each of the heat-dissipating fins is bent to form a folded flange, and the heat-conducting plate is disposed on the folded flanges of the heat-dissipating fins.

7. The bulb-type LED lamp having a replaceable light source module according to claim 4, wherein the heat-conducting plate and the heat-dissipating body are made by aluminum extrusion to form one body, a plurality of heat-dissipating fins extend from an outer surface of the heat-dissipating body, and the heat-conducting plate has a through-hole for allowing the sleeve to be disposed through.

8. A bulb-type LED lamp having a replaceable light source module, including:
a lamp head module having an electrical-conductive connection portion; and
a light source module comprising a substrate, a plurality of LEDs electrically connected to the substrate, and a sleeve electrically connected to the substrate, the sleeve having an electrical-conductive insertion portion, the electrical-conductive insertion portion being assembled with the electrical-conductive connection portion.

9. The bulb-type LED lamp having a replaceable light source module according to claim 8, wherein the lamp head module comprises a threaded head and a connecting piece connected to the threaded head, the threaded head has a first contact and a second contact, the electrical-conductive connection portion is formed on the connecting piece and comprises an electrical-conductive ring and an electrical-conductive post electrically insulated from the electrical-conductive ring, the electrical-conductive post is electrically connected to the first contact, and the electrical-conductive ring is electrically connected to the second contact.

10. The bulb-type LED lamp having a replaceable light source module according to claim 9, wherein the electrical-conductive insertion portion comprises a threaded post and a connecting post electrically insulated from the threaded post, the electrical-conductive ring is provided with an inner thread, the threaded post and the inner thread are threadedly connected with each other to from electrical connection, and the connecting post abuts against the electrical-conductive post to form electrical connection.
